(19) United States
(12) Patent Application Publication
(10) Pub. No.: US 2024/0405394 A1
(43) Pub. Date: Dec. 5, 2024

(54) POWER STORAGE CELL

(71) Applicant: TOYOTA JIDOSHA KABUSHIKI KAISHA, Toyota-shi (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke SUZUKI, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 18/661,930

(22) Filed: May 13, 2024

(30) Foreign Application Priority Data
May 29, 2023 (JP) 2023-087498

(51) Int. Cl. H01M 50/586; H01M 4/36; H01M 10/04

(52) U.S. Cl. CPC H01M 50/586; H01M 4/366; H01M 10/0431

(57) ABSTRACT

A power storage cell includes a first electrode sheet, a second electrode sheet and a separator, the first electrode sheet includes a first current collector and a first electrode composite material layer, the first current collector includes a first uncoated portion, the first uncoated portion includes a plurality of first metal pieces located at a first end portion and arranged in a winding direction of a sheet body, the first metal pieces extend toward a winding axis, and an at least one insulating member includes a first insulating member formed at an edge portion.

### CROSS REFERENCE TO RELATED APPLICATIONS

This nonprovisional application is based on Japanese Patent Application No. 2023-087498 filed on May 29, 2023 with the Japan Patent Office, the entire contents of which are hereby incorporated by reference.

### BACKGROUND

### Field

The present disclosure relates to a power storage cell.

### Description of the Background Art

Japanese Patent No. 4805545 discloses a lithium secondary battery including an internal electrode assembly of winding type that is formed of a positive electrode metal foil and a negative electrode metal foil with a separator between them. The internal electrode assembly has a tabless structure, in which the metal foils (positive electrode and negative electrode) have ends in contact with current-collecting members (positive electrode and negative electrode). The internal electrode assembly is housed in a case.

### SUMMARY

In the power storage cell described above, there is a risk that the positive electrode metal foil contacts a negative electrode composite material layer at one end of the electrode assembly.

A power storage cell includes: an electrode assembly including a sheet body wound to surround a winding axis; and at least one insulating member provided in the electrode assembly, in which the electrode assembly includes a first end portion located at an end in a direction in which the winding axis extends, and a second end portion located at an end opposite to where the first end portion is located, the sheet body includes a first electrode sheet, a second electrode sheet, and a separator disposed between the first electrode sheet and the second electrode sheet, the first electrode sheet includes a first current collector, and a first electrode composite material layer formed on the first current collector, the first current collector includes a first uncoated portion not coated with the first electrode composite material layer, the first uncoated portion includes a plurality of first metal pieces located at the first end portion and arranged in a winding direction of the sheet body, the first metal pieces extend toward the winding axis, the second electrode sheet includes a second current collector, and a second electrode composite material layer formed on the second current collector, the second electrode sheet includes a first edge portion located at the first end portion, and the at least one insulating member includes a first insulating member formed at the first edge portion.

The first insulating member includes a plurality of insulating pieces formed at the first edge portion at a distance from one another, and the distance between the insulating pieces is smaller than a width of each of the first metal pieces. The second current collector includes a second uncoated portion not coated with the second electrode composite material layer, the second uncoated portion includes a plurality of second metal pieces located at the second end portion and arranged in the winding direction, the second metal pieces extend toward the winding axis, the first electrode sheet includes a second edge portion located at the second end portion, and the at least one insulating member includes a second insulating member formed at the second edge portion. The first insulating member includes a welded portion welded to the separator.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a cross-sectional view showing a power storage cell 1 according to the present embodiment.

FIG. 2 is a perspective view schematically showing an electrode assembly 10.

FIG. 3 is a plan view showing a positive electrode sheet 22.

FIG. 4 is a plan view showing a negative electrode sheet 24.

FIG. 5 is a cross-sectional view showing an end portion 5 of electrode assembly 10 and its surroundings.

FIG. 6 is a cross-sectional view showing an end portion 6 of electrode assembly 10 and its surroundings.

FIG. 7 is an enlarged view of a region H1 shown in FIG. 1.

FIG. 8 is an enlarged view of a region H2 shown in FIG. 1.

FIG. 9 is a plan view showing a positive electrode sheet 22A of a power storage cell 1A.

FIG. 10 is a plan view showing a negative electrode sheet 24A of power storage cell 1A.

### DESCRIPTION OF THE PREFERRED EMBODIMENTS

An embodiment of the present disclosure will be described in detail hereinafter with reference to the drawings, in which the same or corresponding portions are denoted by the same reference characters and description thereof will not be repeated.

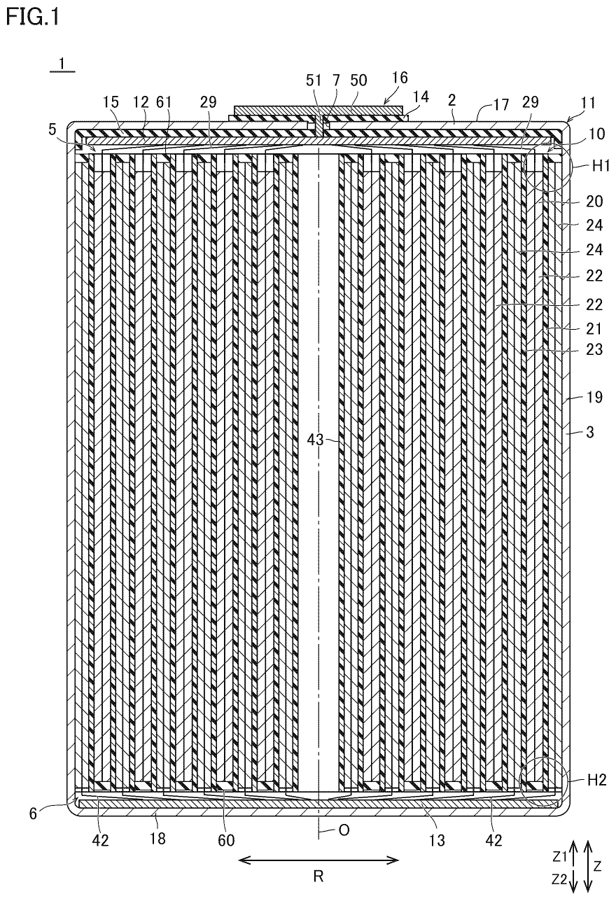

FIG. 1 is a cross-sectional view showing a power storage cell 1 according to the present embodiment. Power storage cell 1 includes a cylindrical electrode assembly 10 formed to surround a winding axis O, a case 11, a positive electrode current-collecting member 12, a negative electrode current-collecting member 13, insulating members 14 and 15, a positive electrode terminal 16, an insulating member (second insulating member) 60, and an insulating member (first insulating member) 61.

In FIG. 1 and the like, “Z” indicates directions in which winding axis O extends, “Z1” indicates one direction of the Z directions, “Z2” indicates the other direction of the Z directions, and “R” indicates the radial direction of electrode assembly 10.

Case 11 includes a top plate 17, a bottom plate 18, and a peripheral wall 19. Case 11 is formed from a metal material. Top plate 17 is located at one end of case 11, and bottom plate 18 is located at the other end of case 11. Peripheral wall 19 is disposed between top plate 17 and bottom plate 18.

Case 11 has a length in the Z directions of, for example, 50 mm or more, 60 mm or more, 70 mm or more, or 80 mm or more. As the height dimension (dimension in axial directions Z) of case 11 increases, power storage cell 1 has a larger storage battery capacity. Case 11 has a height dimension (dimension in axial directions Z) of, for example, 150 mm or less, 100 mm or less, or 80 mm or less. As the dimension in axial directions Z (height dimension) of case 11 decreases, a module that houses power storage cell 1 can have a lower profile.

Case 11 has a diametrical dimension (dimension in radial direction R) of, for example, 15 mm or more, 20 mm or more, 25 mm or more, 30 mm or more, 40 mm or more, 45 mm or more, or 46 mm or more. As the diametrical dimension (maximum dimension in radial direction R) of case 11 increases, power storage cell 1 has a larger storage battery capacity. Case 11 has a diametrical dimension (dimension in radial direction R) of, for example, 100 mm or less, 75 mm or less, 50 mm or less, or 46 mm or less. As the diametrical dimension (dimension in radial direction R) of case 11 decreases, power storage cells 1 can be more densely arranged in the module.

Top plate 17 is provided with a through hole 7. Insulating member 14 is disposed on an outer surface of top plate 17, and is provided with a through hole.

Insulating member 15 includes a top plate portion 2, and a peripheral wall 3 provided at an outer peripheral edge of top plate portion 2. Top plate portion 2 is disposed on an inner surface of top plate 17. Peripheral wall 3 is disposed on an inner peripheral surface of peripheral wall 19. Top plate 17 is provided with a through hole.

Positive electrode terminal 16 includes a flat plate 50 and a shaft 51. Flat plate 50 is disposed on insulating member 14. Shaft 51 is connected to flat plate 50, and is formed to extend in the Z2 direction. Shaft 51 extends through the through hole formed in insulating member 14, through hole 7, and a through hole formed in insulating member 15, to be inserted in case 11.

Positive electrode current-collecting member 12 is disposed on the Z2 direction side relative to insulating member 15. Positive electrode current-collecting member 12 is formed in a plate shape, and has an upper surface welded to a lower end of shaft 51. Positive electrode current-collecting member 12 is formed from aluminum, for example.

Negative electrode current-collecting member 13 is disposed on an inner surface of bottom plate 18. Negative electrode current-collecting member 13 is formed in a plate shape, and is formed from a metal material such as copper.

Electrode assembly 10 is disposed between positive electrode current-collecting member 12 and negative electrode current-collecting member 13 in case 11.

Electrode assembly 10 includes an end portion (first end portion) 5 located at the Z1 direction side, with positive electrode current-collecting member 12 disposed at end portion 5. Electrode assembly 10 includes an end portion (second end portion) 6 located at the Z2 direction side, with negative electrode current-collecting member 13 disposed at end portion 6. Electrode assembly 10 is formed to be hollow, and has a hollow portion 43 formed therein. Hollow portion 43 is formed at a position passing through winding axis O.

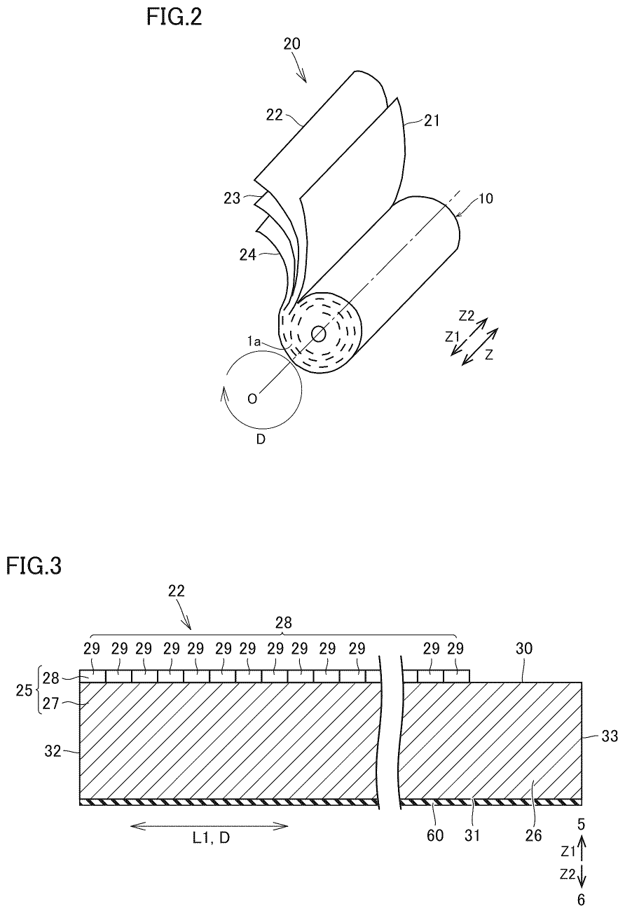

FIG. 2 is a perspective view schematically showing electrode assembly 10. Electrode assembly 10 includes a sheet body 20 formed to surround winding axis O. Note that “D” indicates a direction in which sheet body 20 extends in electrode assembly 10 in the wound state.

Sheet body 20 is formed to be elongated in winding direction D of electrode assembly 10. Sheet body 20 includes a separator 21, a positive electrode sheet (first electrode sheet) 22, a separator 23, and a negative electrode sheet (second electrode sheet) 24.

FIG. 3 is a plan view showing positive electrode sheet 22. Positive electrode sheet 22 shown in FIG. 3 has been unwound and expanded from the state of being wound into electrode assembly 10. Positive electrode sheet 22 includes a longer side 30, a longer side (second edge portion) 31, and shorter sides 32 and 33. Longer sides 30 and 31 extend in an L1 direction in which positive electrode sheet 22 extends. The L1 direction corresponds to winding direction D of electrode assembly 10 in the wound state. Longer side 30 is located at end portion 5 of electrode assembly 10 in the wound state, and longer side 31 is located at end portion 6 of electrode assembly 10 in the wound state.

Positive electrode sheet 22 includes a positive electrode current-collecting plate (first current collector) 25 and a positive electrode composite material layer (first electrode composite material layer) 26. Positive electrode current-collecting plate 25 is formed from a metal material such as aluminum or an aluminum alloy.

Positive electrode composite material layer 26 includes a positive electrode active material, a binder and the like. Examples of the positive electrode active material include LiCoO₂, LiNo₂, and LiMn₂O₄. Positive electrode composite material layer 26 has a thickness of, for example, 0.1 μm or more and 1000 μm or less.

Positive electrode current-collecting plate 25 includes a coated portion 27 on which positive electrode composite material layer (first electrode composite material layer) 26 is formed, and an uncoated portion (first uncoated portion) 28 on which positive electrode composite material layer 26 is not formed. While positive electrode composite material layer 26 is formed on both of front and back surfaces of positive electrode current-collecting plate 25, positive electrode composite material layer 26 may be formed on one of these surfaces. Uncoated portion 28 is formed at longer side 30. Uncoated portion 28 includes a plurality of positive electrode metal pieces 29 arranged in the L1 direction.

Insulating member 60 is formed at longer side 31. Insulating member 60 is formed to extend in the L1 direction. Thus, the edge portion of positive electrode composite material layer 26 at longer side 31 is covered by insulating member 60.

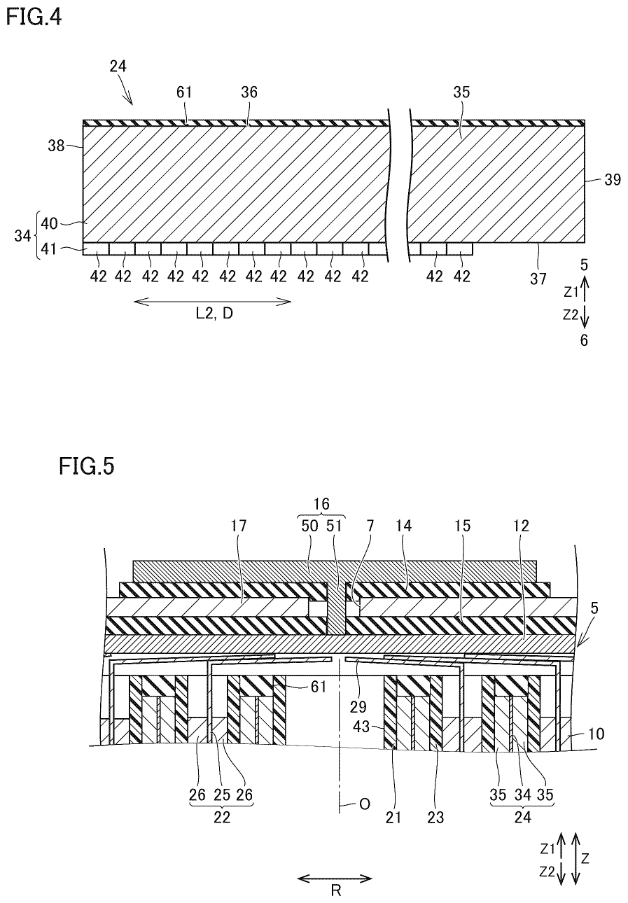

FIG. 4 is a plan view showing negative electrode sheet 24. Negative electrode sheet 24 shown in FIG. 4 has been unwound and expanded from the state of being wound into electrode assembly 10. Negative electrode sheet 24 includes a negative electrode current-collecting plate (second current collector) 34 and a negative electrode composite material layer (second electrode composite material layer) 35. Negative electrode sheet 24 includes a longer side (first edge portion) 36, a longer side 37, and shorter sides 38 and 39. Longer sides 36 and 37 extend in an L2 direction in which negative electrode sheet 24 extends. Longer side 36 is located at end portion 5 of electrode assembly 10 in the wound state, and longer side 37 is located at end portion 6 of electrode assembly 10 in the wound state.

Negative electrode composite material layer 35 includes a negative electrode active material, a binder and the like. Examples of the negative electrode active material include graphite. Negative electrode composite material layer 35 has a thickness of, for example, 0.1 μm or more and 1000 μm or less.

Negative electrode current-collecting plate 34 includes a metal material such as copper. Negative electrode current-collecting plate 34 includes a coated portion 40 on which negative electrode composite material layer 35 is formed, and an uncoated portion (second uncoated portion) 41 on which negative electrode composite material layer 35 is not formed. Uncoated portion 41 is formed at longer side 37. Uncoated portion 41 includes a plurality of negative electrode metal pieces 42 arranged in the L2 direction.

Insulating member 61 is formed at longer side 36. Insulating member 61 is formed to extend in the L2 direction. Thus, the edge portion of negative electrode current-collecting plate 34 at longer side 36 is covered by insulating member 61.

In FIG. 1, negative electrode composite material layer 35 is formed to have a length longer than the length of positive electrode composite material layer 26 in the Z directions.

FIG. 5 is a cross-sectional view showing end portion 5 of electrode assembly 10 and its surroundings. Negative electrode composite material layer 35 and positive electrode composite material layer 26 are disposed to face each other with separator 21 or separator 23 interposed therebetween. In the Z1 direction, negative electrode sheet 24 is located closer to positive electrode current-collecting member 12 than positive electrode sheet 22. In the Z1 direction, separators 21 and 23 are located closer to positive electrode current-collecting member 12 than negative electrode composite material layer 35 and positive electrode composite material layer 26.

Positive electrode metal piece 29 extends in the Z1 direction from positive electrode composite material layer 26, and then extends toward winding axis O (hollow portion 43). Positive electrode metal piece 29 is welded to positive electrode current-collecting member 12.

On the end portion 5 side of electrode assembly 10, insulating member 61 is formed at the edge portion of negative electrode sheet 24. Thus, contact of positive electrode metal piece 29 with negative electrode composite material layer 35 is suppressed.

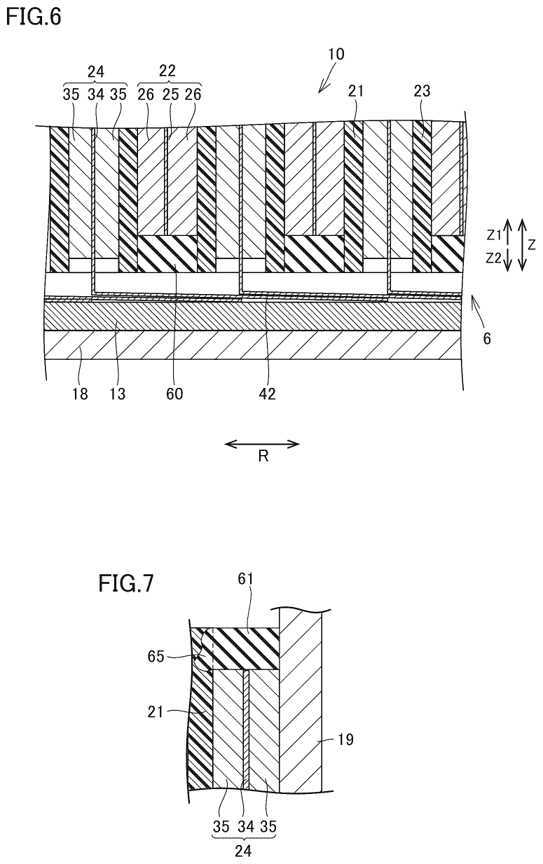

FIG. 6 is a cross-sectional view showing end portion 6 of electrode assembly 10 and its surroundings. Negative electrode metal piece 42 extends in the Z2 direction from negative electrode composite material layer 35, and then extends toward winding axis O (hollow portion 43). Negative electrode metal piece 42 is welded to negative electrode current-collecting member 13. On the end portion 6 side of electrode assembly 10, insulating member 60 is formed at the edge portion of positive electrode sheet 22. Thus, contact of negative electrode metal piece 42 with positive electrode composite material layer 26 is suppressed.

In the Z2 direction, positive electrode sheet 22 is further away from negative electrode current-collecting member 13 than negative electrode sheet 24. On the end portion 6 side of electrode assembly 10, positive electrode sheet 22 and negative electrode sheet 24 form a spiral groove. Insulating member 60 is disposed in this spiral groove, and is prevented from falling out.

In the Z2 direction, separators 21 and 23 are located closer to negative electrode current-collecting member 13 than negative electrode composite material layer 35 and positive electrode composite material layer 26.

FIG. 7 is an enlarged view of a region H1 shown in FIG. 1. A portion of insulating member 61 that is located at an outermost peripheral portion of electrode assembly 10 includes a welded portion 65 which penetrates and is bonded to adjacent separator 21.

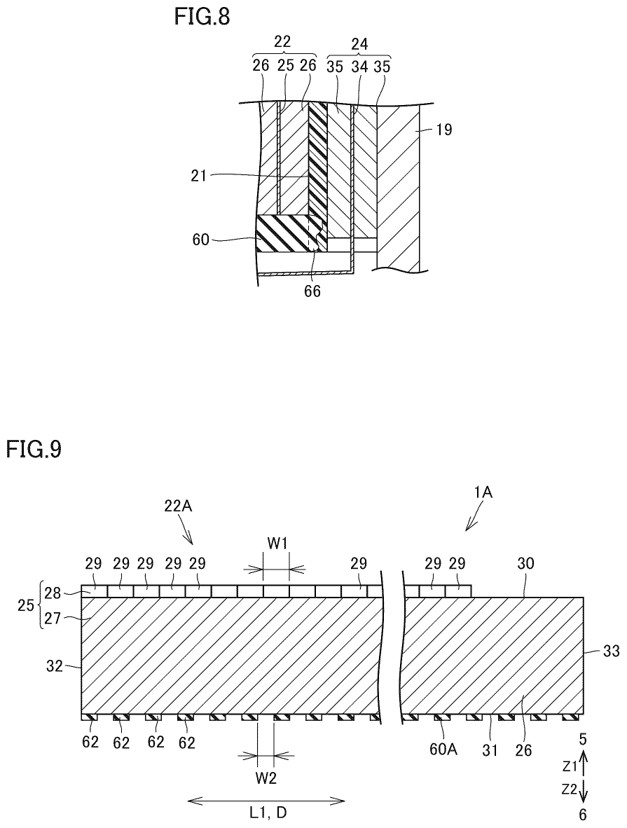

FIG. 8 is an enlarged view of a region H2 shown in FIG. 1. A portion of insulating member 60 that is located at the outermost peripheral portion of electrode assembly 10 includes a welded portion 66 which penetrates and is bonded to adjacent separator 21.

Welded portions 65 and 66 are formed by initially winding sheet body 20. End portions 5 and 6 are then heated from the outer peripheral surface side of wound sheet body 20. As a result, insulating members 60 and 61 partially melt and penetrate separators 21 and 23. They subsequently cool and solidify to form welded portions 65 and 66.

By forming such welded portions 65 and 66, sheet body 20 can be maintained in the wound state without a fixing tape or the like. Welded portions 65 and 66 are formed to extend for about a single winding in winding direction D from a portion located at the terminal end of sheet body 20.

### First Modification

A power storage cell 1A according to a modification is described with reference to FIG. 9 and the like. Power storage cell 1A is substantially identical in configuration to power storage cell 1, except for configurations of insulating members 60A and 61A described later.

FIG. 9 is a plan view showing a positive electrode sheet 22A of power storage cell 1A. Power storage cell 1A includes an insulating member 60A formed at longer side 31. Insulating member 60A includes a plurality of insulating pieces 62. Insulating pieces 62 are formed at a distance from one another in the L1 direction.

Note that a “width W1” indicates the width of each positive electrode metal piece 29 in the L1 direction, and a “distance W2” indicates the distance between insulating pieces 62 in the L1 direction.

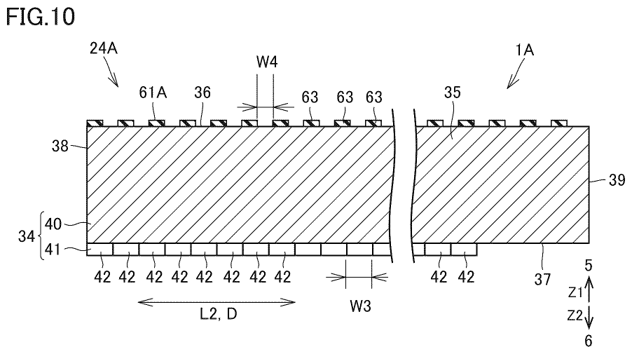

FIG. 10 is a plan view showing a negative electrode sheet 24A of power storage cell 1A. Power storage cell 1A includes an insulating member 61A formed at longer side 36. Insulating member 61A includes a plurality of insulating pieces 63. Insulating pieces 63 are formed at a distance from one another in the L2 direction.

Note that a “width W3” indicates the width of each negative electrode metal piece 42 in the L2 direction, and a “distance W4” indicates the distance between insulating pieces 63 in the L2 direction. Distance W4 is smaller than width W1. Width W3 is smaller than distance W2.

For example, widths W1 and W3 are each 3.0 mm or more and 6.0 mm or less. If width W1 of positive electrode metal piece 29 is less than 3.0 mm, positive electrode metal piece 29 is susceptible to fracture. If width W1 of positive electrode metal piece 29 is more than 6.0 mm, each positive electrode metal piece 29 is susceptible to wrinkles and the like when bent in radial direction R as shown in FIG. 5. This may cause a crack in positive electrode metal piece 29, resulting in fracture of a part of positive electrode metal piece 29. This is also the case for negative electrode metal piece 42. For example, widths W1 and W3 are each 4.0 mm or more and 5.0 mm or less.

Distances W2 and W4 are each 2.0 mm or more and 4.0 mm or less. If distance W2 between insulating pieces 62 is less than 2.0 mm, entry into electrode assembly 10 through the gap between insulating pieces 62 is difficult. If distance W2 between insulating pieces 62 is more than 4.0 mm, corners of negative electrode metal piece 42 readily enter the gap between insulating pieces 62, for example, causing negative electrode metal piece 42 to readily contact positive electrode composite material layer 26. This is also the case for distance W4 between insulating pieces 63.

Positive electrode metal piece 29 has a length in the Z1 direction of, and negative electrode metal piece 42 has a length in the Z2 direction of, for example, 1.0 mm or more and 23 mm or less.

If the length of positive electrode metal piece 29 in the Z1 direction is less than 1.0 mm, it is difficult to weld positive electrode metal piece 29 to positive electrode current-collecting member 12. If the length of positive electrode metal piece 29 in the Z1 direction is more than 23 mm, positive electrode metal pieces 29 excessively overlap one another when bent as shown in FIG. 5. This increases the gap between end portion 5 of electrode assembly 10 and positive electrode current-collecting member 12, resulting in an increased size of power storage cell 1. This is also the case for negative electrode metal piece 42. For example, positive electrode metal piece 29 may have a length in the Z1 direction of, and negative electrode metal piece 42 may have a length in the Z2 direction of, for example, 0.1 mm or more, 0.5 mm or more, 5 mm or more, 10 mm or more, or 20 mm or more, or 20 mm or less, 15 mm or less, 10 mm or less, or 5 mm or less.

In an electrode assembly 10A including positive electrode sheet 22A and negative electrode sheet 24A wound as described above, a gap is formed between adjacent insulating pieces 62 and between adjacent insulating pieces 63.

In a manufacturing process of power storage cell 1A, an electrolyte solution is injected into case 11, with electrode assembly 10A housed in case 11. At this time, the electrolyte solution readily enters electrode assembly 10A through the gap between adjacent insulating pieces 62 and the gap between adjacent insulating pieces 63.

In addition, since distance W4 between insulating pieces 63 is smaller than width W1 of positive electrode metal piece 29, entry of positive electrode metal piece 29 through the gap between insulating pieces 63 is suppressed. Accordingly, contact of positive electrode metal piece 29 with negative electrode composite material layer 35 is suppressed.

In addition, since distance W2 between insulating pieces 62 is smaller than width W3 of negative electrode metal piece 42, entry of negative electrode metal piece 42 through the gap between insulating pieces 62 is suppressed. Accordingly, contact of negative electrode metal piece 42 with positive electrode composite material layer 26 is suppressed.

Although the embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A power storage cell comprising:
an electrode assembly including a sheet body wound to surround a winding axis; and
at least one insulating member provided in the electrode assembly, wherein
the electrode assembly includes a first end portion located at an end in a direction in which the winding axis extends, and a second end portion located at an end opposite to where the first end portion is located,
the sheet body includes a first electrode sheet, a second electrode sheet, and a separator disposed between the first electrode sheet and the second electrode sheet,
the first electrode sheet includes a first current collector, and a first electrode composite material layer formed on the first current collector,
the first current collector includes a first uncoated portion not coated with the first electrode composite material layer,
the first uncoated portion includes a plurality of first metal pieces located at the first end portion and arranged in a winding direction of the sheet body,
the first metal pieces extend toward the winding axis,
the second electrode sheet includes a second current collector, and a second electrode composite material layer formed on the second current collector,
the second electrode sheet includes a first edge portion located at the first end portion, and
the at least one insulating member includes a first insulating member formed at the first edge portion.

2. The power storage cell according to claim 1, wherein
the first insulating member includes a plurality of insulating pieces formed at the first edge portion at a distance from one another, and
the distance between the insulating pieces is smaller than a width of each of the first metal pieces.

3. The power storage cell according to claim 1, wherein
the second current collector includes a second uncoated portion not coated with the second electrode composite material layer,
the second uncoated portion includes a plurality of second metal pieces located at the second end portion and arranged in the winding direction,
the second metal pieces extend toward the winding axis,
the first electrode sheet includes a second edge portion located at the second end portion, and
the at least one insulating member includes a second insulating member formed at the second edge portion.

4. The power storage cell according to claim 1, wherein
the first insulating member includes a welded portion welded to the separator.
